(19) United States
(12) Patent Application Publication
(10) Pub. No.: US 2004/0027945 A1
(43) Pub. Date: Feb. 12, 2004

(54) Information recording/reproducing apparatus and information reproducing method

(75) Inventor: Hideki Kobayashi, Tsurugashima-shi (JP)

Correspondence Address: SUGHRUE MION, PLLC, 2100 PENNSYLVANIA AVENUE, N.W., WASHINGTON, DC, 20037, US

(73) Assignee: PIONEER CORPORATION

(21) Appl. No.: 10/618,711

(22) Filed: Jul. 15, 2003

(30) Foreign Application Priority Data
Aug. 9, 2002 (JP) 2002-232880

(51) Int. Cl. G11B 7/00

(52) U.S. Cl. 369/47.22; 369/53.35

(57) ABSTRACT

An information recording/reproducing apparatus and an information reproducing method which are capable of reproducing information such as addresses previously recorded on a recording medium without fail. For reproducing an address from a recording medium on which multiplexed addresses, each indicative of a recording position on the recording medium, which are modulated by at least two types of modulation processing is recorded, demodulation processing is first performed on a read signal read from the recording medium corresponding to each of the modulation processing to generate an address data signal for each demodulation processing. Next, error correction processing is performed on these address data signals to generate corrected address data signals corresponding to the respective address data signals. Then, the corrected address data signal corresponding to the address data signal having the lowest error ratio is selected from the address data signals, and outputted as a reproduced address.

### BACKGROUND OF THE INVENTION

1. Field of the Invention

The present invention relates to an information recording/reproducing apparatus and an information reproducing method.

2. Description of the Related Art

In recent years, recording discs such as CD-RW and DVD-RW on which information data can be written, and a disc recorder for writing information data into such a recording disc have become increasingly popular. Such a recording disc has addresses indicative of positions on the disc (hereinafter called the “disc address”) previously recorded thereon. The disc recorder reproduces the disc address from the recording disc to recognize a recording position on the disc and start writing information data from a desired recording position.

However, scratches, fingerprints, dust or the like on the surface of the recording disc prevents the disc recorder from correctly reading the disc address from the recording disc, resulting in a failure to write information data correctly into the disc.

The present invention has been made to solve the problem as mentioned above, and it is an object of the invention to provide an information recording/reproducing apparatus and an information reproducing method which are capable of reproducing information such as addresses previously recorded on a recording medium without fail.

### SUMMARY OF THE INVENTION

According to the present invention in a first aspect there is provided an information recording/reproducing apparatus for reproducing an address indicative of a recording position on a recording medium from the recording medium on which address data obtained by modulating the address in at least two modulation schemes different from each other are recorded. The information recording/reproducing apparatus has a demodulator which performs demodulation processing on a read signal read from the recording medium corresponding to each of the modulation schemes to generate an address data signal for each demodulation processing, an error corrector which performs an error correction processing on each of the address data signals to generate a corrected address data signal corresponding to each of the address data signals, and an address output part which outputs the corrected address data signal corresponding to the address data signal having the lowest error ratio among the address data signals as a reproduced address.

According to the present invention in a second aspect there is provided an information recording/reproducing apparatus for reproducing an address indicative of a recording position on a recording medium from the recording medium on which address data obtained by modulating the address in at least two modulation schemes different from each other are recorded. The information recording/reproducing apparatus has a demodulator which performs demodulation processing on a read signal read from the recording medium corresponding to each of the modulation scheme to generate an address signal for each demodulation processing, a combining part which combines the respective read signals generated for the respective demodulation schemes with one another at combination ratios different from one another to generate a plurality of combined read address signals, an address generator which performs a binary determination on each of the combined read address signals to generate an address data signal, an error corrector which performs an error correction processing on each of the address data signals to generate a corrected address data signal corresponding to each of the address data signals, and an address output part which means which outputs the corrected address data corresponding to the address data signal having the lowest error ratio among the address data signals as a reproduced address.

According to the present invention in another aspect there is provided an information reproducing method is provided for reproducing an address indicative of a recording position on a recording medium from the recording medium on which address data obtained by modulating the address in at least two modulation schemes different from each other are recorded. The information reproducing method has a demodulating step for performing a demodulation processing on a read signal read from the recording medium corresponding to each of the modulation schemes to generate an address data signal for each demodulation processing, an error correcting step for performing error correction processing on each of the address data signals to generate a corrected address data signal corresponding to each of the address data signals, and an address outputting step for outputting the corrected address data signal corresponding to the address data signal having the lowest error ratio among the address data signals as a reproduced address.

According to the present invention in a further aspect there is provided an information reproducing method for reproducing an address indicative of a recording position on a recording medium from the recording medium on which the address data obtained by modulating the address in at least two modulation schemes different from each other are recorded. The method has a demodulating step for performing a demodulation processing on a read signal read from the recording medium corresponding to each of the modulation schemes to generate an address signal for each demodulation processing, a combining step for combining the respective read signals generated for the respective demodulation schemes with one another at combination ratios different from one another to generate a plurality of combined read address signals, an address generating step for performing a binary determination on each of the combined read address signals to generate an address data signal, an error correcting step for performing error correction processing on each of the address data signals to generate a corrected address data signal corresponding to each of the address data signals, and an address outputting step for outputting the corrected address data corresponding to the address data signal having the lowest error ratio among the address data signals as a reproduced address.

### BRIEF DESCRIPTION OF THE DRAWINGS

FIG. 1 is a diagram illustrating the configuration of a master recording apparatus for manufacturing a recording disc;

FIG. 2 is a diagram illustrating by way of example how address signals are multiplexed;

FIG. 3 is a diagram illustrating an exemplary configuration of an information recording/reproducing apparatus;

FIG. 4 is a diagram showing the positioning of photodetectors 20a-20d mounted in a recording/reproducing head 32;

FIG. 5 is a diagram illustrating another exemplary configuration of the information recording/reproducing apparatus;

FIG. 6 is a diagram illustrating an exemplary internal configuration of a combining circuit 50;

FIG. 7 is a diagram illustrating an exemplary variation of the information recording/reproducing apparatus illustrated in FIG. 3; and

FIG. 8 is a diagram illustrating an exemplary variation of the information recording/reproducing apparatus illustrated in FIG. 5.

### DETAILED DESCRIPTION OF THE INVENTION

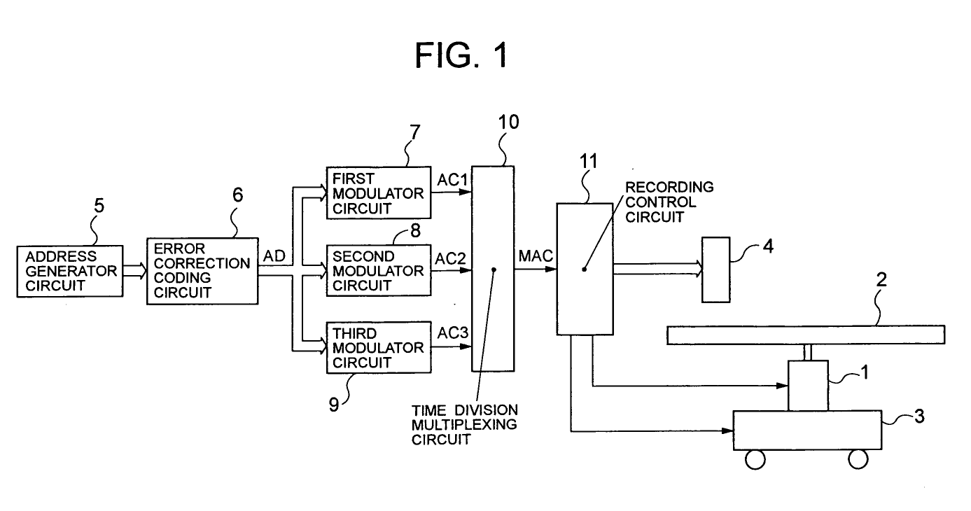

FIG. 1 is a diagram illustrating the configuration of a master recording apparatus for manufacturing a recording disc on which information data can be written.

In FIG. 1, a spindle motor 1 rotates a master 2 which has a resist layer formed on its surface for an electron beam. A feed stage 3 moves the master 2 and spindle motor 1 in a radial direction of the master 2. An electron beam irradiation device 4 projects an electron beam onto the surface of the resist layer on the master 2.

An address generator circuit 5 generates a disc address indicative of a position on a recording disc which is supplied to an error correction coding circuit 6. The error correction coding circuit 6 adds redundant bits for error correction to the disc address to generate coded address data AD which is supplied to each of a first modulator circuit 7, a second modulator circuit 8 and a third modulator circuit 9. The first modulator circuit 7 performs first predetermined modulation on the coded address data AD to generate a first modulated signal AC1 which is supplied to a time division multiplexing circuit 10. The second modulator circuit 8 performs second modulation, which is different from the first modulation in modulation scheme, on the coded address data AD to generate a second modulated address signal AC2 which is supplied to the time division multiplexing circuit 10. The third modulator circuit 9 performs third modulation, which is different from any of the first modulation and second modulation, on the coded address data AD to generate a third modulated address signal AC3 which is supplied to the time-division multiplexing circuit 10.

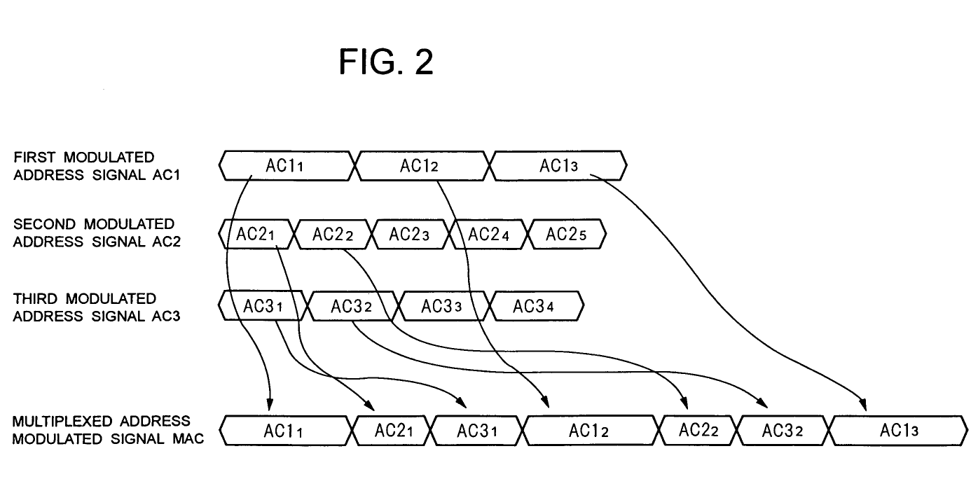

The time-division multiplexing circuit 10 time-division multiplexes the first modulated address signal AC1, second modulated address signal AC2 and third modulated address signal C3 in a format, for example, as illustrated in FIG. 2, to generate a multiplexed address modulated signal MAC which is supplied to a recording control circuit 11.

The recording control circuit 11 controls the electron beam irradiation device 4 to project an electron beam onto the surface of the resist layer on the master 2 while oscillating an electron beam irradiation axis in radial directions of the disc in accordance with the multiplexed address modulated signal MAC. Further, the recording control circuit 11 controls the feed stage 3 to gradually move the position to which the electron beam is projected on the surface of the resist layer from the inner periphery to the outer periphery of the disc.

With the operation as described above, a latent image is formed in a region which is irradiated with the electron beam on the surface of the resist layer on the master 2. Specifically, the latent image formed on the surface of the resist layer on the master 2 carries a recording track which wobbles in accordance with the waveform of the multiplexed address modulated signal MAC. Upon completion of the recording on the resist layer on the master 2 (formation of the latent image), the latent image formed on the resist layer alone is removed to create a mask pattern. Next, this mask pattern is used to create a convex or a concave stamper which carries the recording track. Then, this stamper is used to duplicate recording discs which have a recording track that wobbles in accordance with the waveform of the multiplexed address modulated signal MAC.

Specifically, the recording disc has the disc addresses modulated in the three different modulation schemes from one another, recorded in time-division multiplexed sequence.

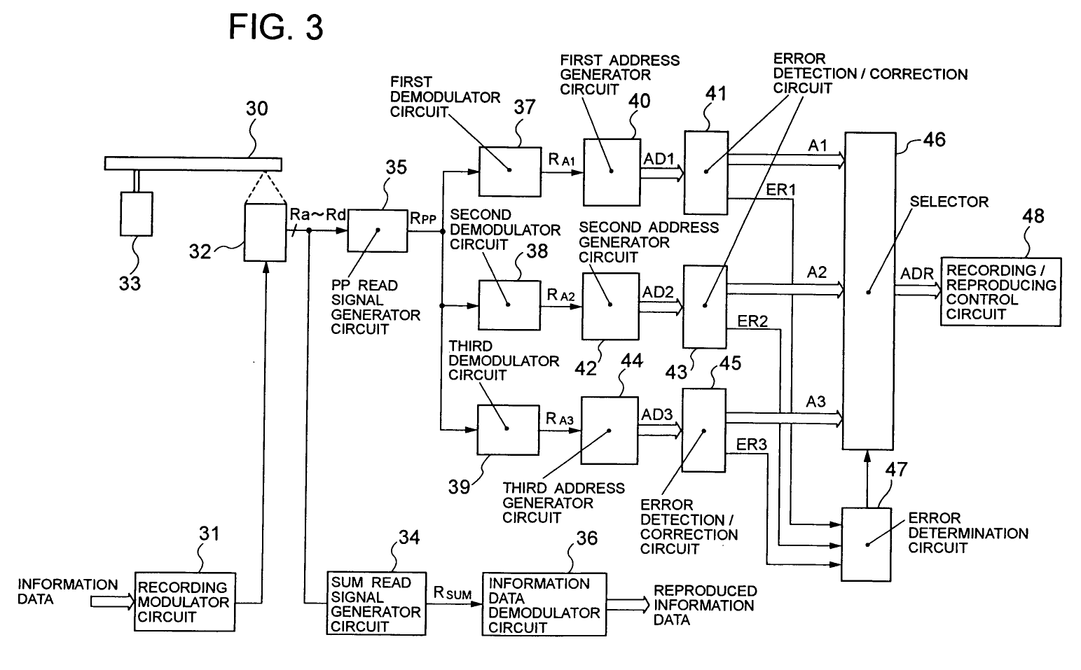

FIG. 3 is a diagram illustrating the configuration of an information recording/reproducing apparatus for recording or reproducing information data on or from the recording disc.

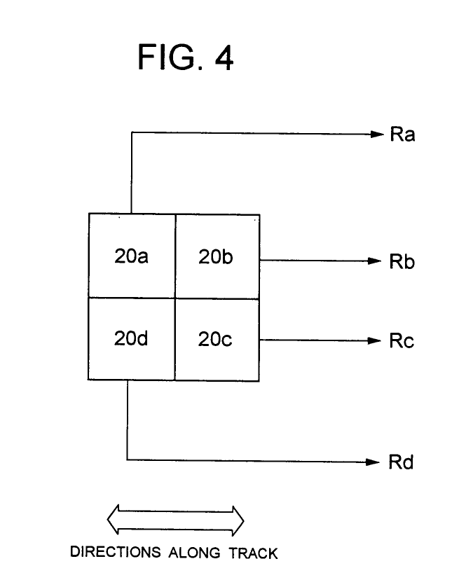

In FIG. 3, a recording modulator circuit 31 modulates information data to be recorded on a recording disc in accordance with a predetermined recording modulation scheme to generate a modulated recording signal which is supplied to a recording/reproducing head 32. The recording/reproducing head 32 projects a recording light beam or reading beam light onto a recording surface of a recording disc 30 which is rotated by a spindle motor 33. Specifically, the recording/reproducing head 32 projects a recording light beam onto the recording surface of the recording disc 30 when information data is recorded on the recording disc 30, i.e., in a recording operation. On the other hand, when information data is reproduced from the recording disc 30, i.e., in a reproducing operation, the recording/reproducing head 32 projects a reading light beam onto the recording surface of the recording disc 30, and reflected light therefrom is received by four photodetectors 20a-20d which are arranged as shown in FIG. 4. Each of the photodetectors 20a-20d mounted in the recording/reproducing head 32 photo-electrically transduces the received reflected light to generate a read signal Ra-Rd which is supplied to each of a sum read signal generator circuit 34 and a push-pull read signal generator circuit 35. The sum read signal generator circuit 34 adds the read signals Ra-Rd to generate a sum read signal Rₛᵤₘ which is supplied to an information data demodulator circuit 36. The information data demodulator circuit 36 performs predetermined demodulation processing on the sum read signal Rₛᵤₘ to recover information data recorded on the recording disc 30, which is outputted as reproduced information data.

The push-pull read signal generator circuit 35 generates a push-pull read signal R_{PP} by the following operation using the read signals Ra-Rd, and supplies the push-pull read signal R_{PP} to a first demodulator circuit 37, a second demodulator circuit 38 and a third demodulator circuit 39, respectively:

R_{PP}=(Ra+Rb)−(Rc+Rd)

The first demodulator circuit 37 performs demodulation processing corresponding to the first modulation performed by the first modulator circuit 7 on the push-pull read signal R_{PP} to demodulate a read signal corresponding to the coded address data AD which is supplied to a first address generator circuit 40 as a first address read signal R_{A1}. The first address generator circuit 40 performs a binary determination on the first address read signal R_{A1} to generate coded address data which is supplied to an error detection/correction circuit 41 as coded address data AD1. The error detection/correction circuit 41 performs error detection processing on the coded address data AD1, and supplies an error determination circuit 47 with a detection result signal ER1 which indicates the result of the error detection. The error detection/correction circuit 41 further performs error correction processing on the coded address data AD1, and supplies a selector 46 with corrected address data A1 which is corrected for errors.

The second demodulator circuit 38 performs demodulation processing corresponding to the second modulation performed by the second modulator circuit 8 on the push-pull read signal R_{PP} to demodulate a read signal corresponding to the coded address data AD which is supplied to a second address generator circuit 42 as a second address read signal R_{A2}. The second address generator circuit 42 performs a binary determination on the second address read signal R_{A2} to generate coded address data which is supplied to an error detection/correction circuit 43 as coded address data AD2. The error detection/correction circuit 43 performs error detection processing on the coded address data AD2, and supplies the error determination circuit 47 with a detection result signal ER2 which indicates the result of the error detection. The error detection/correction circuit 43 further performs error correction processing on the coded address data AD2, and supplies the selector 46 with corrected address data A2 which is corrected for errors.

The third demodulator circuit 39 performs demodulation processing corresponding to the third modulation performed by the second modulator circuit 9 on the push-pull read signal R_{PP} to demodulate a read signal corresponding to the coded address data AD which is supplied to a third address generator circuit 44 as a third address read signal R_{A3}. The third address generator circuit 44 performs a binary determination on the third address read signal R_{A3} to generate coded address data which is supplied to an error detection/correction circuit 45 as coded address data AD3. The error detection/correction circuit 45 performs error detection processing on the coded address data AD3, and supplies the error determination circuit 47 with a detection result signal ER3 which indicates the result of the error detection. The error detection/correction circuit 45 further performs error correction processing on the coded address data AD3, and supplies the selector 46 with corrected address data A3 which is corrected for errors.

Each of the error detection result signals ER1-ER3 represents, for example, the following four error conditions C0-C3:

C0: no error

C1: error correctable, number of errors in one code block=1

C2: error correctable, number of errors in one code block=2

C3: error uncorrectable.

Specifically, in the error condition C0, no error exists in the coded address data AD, so that the corrected address data is most reliable. In the error condition C1, one error symbol exists in each of code blocks in the coded address data AD, so that even if the error is corrected by the error detection/correction circuit, the corrected address data A after the correction has a lower reliability than in the error condition C0. In the error condition C2, two errors exists in each of the code blocks in the coded address data AD, so that even if the errors are corrected by the error detection/correction circuit, the corrected address data after the correction has a lower reliability than in the error condition C1. Further, in the error condition C3, since errors cannot be corrected by the error detection/correction circuit, the corrected address data A has the lowest reliability.

The error determination circuit 47 determines the error detection result signal ER, among the error detection result signals ER1-ER3, which represents the error condition with the least number of correctable errors (the number of errors per code block), i.e., the error condition in which errors can be corrected and the error rate is lowest. Then, the error determination circuit 47 supplies the selector 46 with a selection signal for selecting corrected address data A which corresponds to the determined error detection result signal ER.

The selector 46 selects one from the corrected address data A1-A3 supplied from the error detection/correction circuits 41, 43, 45, respectively, in accordance with the selection signal, and supplies the selected data to a recording/reproducing control circuit 48 as a reproduced disc address ADR. The recording/reproducing control circuit 48 controls a slider mechanism (not shown) for carrying the recording/reproducing head 32, spindle motor 33 and recording/reproducing head 32 in a radial direction of the disc in order for the information recording/reproducing apparatus to perform a variety of recording operations and reproducing operations in response to a variety of manipulations from the user. During a recording operation, the recording/reproducing control circuit 48 searches for a desired disc position on the recording disc 30 based on the reproduced disc address ADR in order to start recording from the desired position.

As described above, in the information recording/reproducing apparatus illustrated in FIG. 3, disc addresses modulated in three modulation schemes (first modulation-third modulation) different from one another are individually demodulated from a read signal read from the recording disc 30 to generate the coded address data AD1-AD3. Next, each of the coded address data AD1-AD3 is corrected for errors to generate corrected address data A1-A3. Further, error detection is performed individually on each of the coded address data AD1-AD3 to generate the error detection result signal ER1-ER3 which represents an error condition of the respective coded address data AD1-AD3. Then, the information recording/reproducing apparatus selects the corrected address data A, which corresponds to the error detection result signal ER that represents a correctable error condition with the lowest error rate, from the error detection result signals ER1-ER3 as a final reproduced disc address.

Thus, according to the information recording/reproducing apparatus illustrated in FIG. 3, a relatively reliable disc address can be acquired from the recording disc, even if scratches, finger prints, dust and the like stick to the surface of the recording disc.

While in the foregoing embodiment, the disc address is modulated in three modulation schemes different from one another, time-division-multiplexed and recorded on a recording disc, the number in which the disc address is modulated and time-division-multiplexed may be two or a plural number equal to or larger than four.

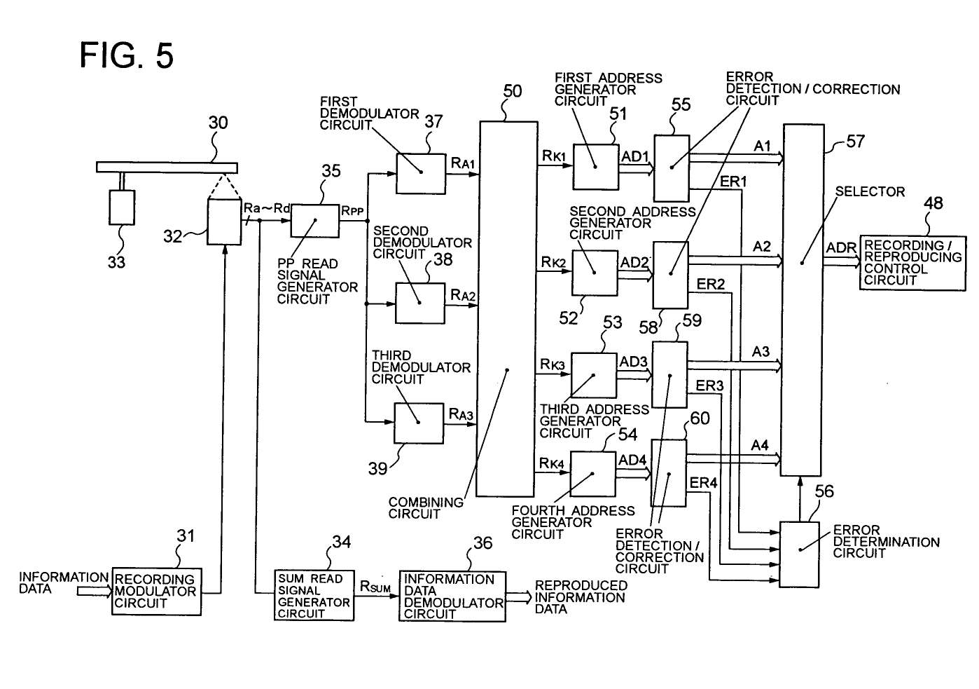

FIG. 5 is a diagram illustrating the configuration of another information recording/reproducing apparatus.

Since the operation of each of a recording disc 30, a recording modulator circuit 31, a recording/reproducing head 32, a spindle motor 33, a sum read signal generator circuit 34, a push-pull read signal generator circuit 35, an information data demodulator circuit 36, first to third demodulator circuits 37-39, and a recording/reproducing control circuit 48 is identical to their counterparts illustrated in FIG. 3, description thereon is omitted.

In FIG. 5, a combining circuit 50 combines each of a first address read signal R_{A1} to a third address read signal R_{A3} supplied from the first demodulator circuit 37, second demodulator circuit 38 and third demodulator circuit 39 at different combination ratios to generate four combined address read signals R_{K1}-R_{K4}.

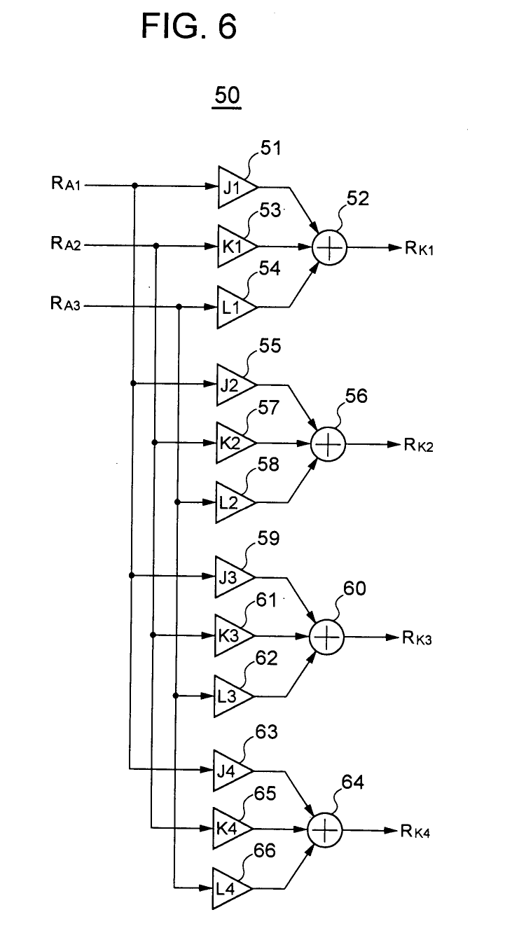

FIG. 6 is a diagram illustrating the internal configuration of the combining circuit 50.

In FIG. 6, a coefficient multiplier 51 multiplies the first address read signal R_{A1} by a predetermined coefficient J1 to generate a multiplication result which is supplied to an adder 52. A coefficient multiplier 53 multiplies the second address read signal R_{A2} by a predetermined coefficient K1 to generate a multiplication result which is supplied to the adder 52. A coefficient multiplier 54 multiplies the third address read signal R_{A3} by a predetermined coefficient L1 to generate a multiplication result which is supplied to the adder 52. The adder 52 adds the multiplication results of the respective coefficient multipliers 51, 53, 54 to output the sum as a combined address read signal R_{K1}.

A coefficient multiplier 55 multiplies the first address read signal R_{A1} by a predetermined coefficient J2 to generate a multiplication result which is supplied to an adder 56. A coefficient multiplier 57 multiplies the second address read signal R_{A2} by a predetermined coefficient K2 to generate a multiplication result which is supplied to the adder 56. A coefficient multiplier 58 multiplies the third address read signal R_{A3} by a predetermined coefficient L2 to generate a multiplication result which is supplied to the adder 56. The adder 56 adds the multiplication results of the respective coefficient multipliers 55, 57, 58 to output the sum as a combined address read signal R_{K2}.

A coefficient multiplier 59 multiplies the first address signal R_{A1} by a predetermined coefficient J3 to generate a multiplication result which is supplied to an adder 60. A coefficient multiplier 61 multiplies the second address read signal R_{A2} by a predetermined coefficient K3 to generate a multiplication result which is supplied to the adder 60. A coefficient multiplier 62 multiplies the third address read signal R_{A3} by a predetermined coefficient L3 to generate a multiplication result which is supplied to the adder 60. The adder 60 adds the multiplication results of the respective coefficient multipliers 59, 61, 62 to output the sum as a combined address read signal R_{K3}.

A coefficient multiplier 63 multiplies the first address signal R_{A1} by a predetermined coefficient J4 to generate a multiplication result which is supplied to an adder 64. A coefficient multiplier 65 multiplies the second address read signal R_{A2} by a predetermined coefficient K4 to generate a multiplication result which is supplied to the adder 64. A coefficient multiplier 66 multiplies the third address read signal R_{A3} by a predetermined coefficient L4 to generate a multiplication result which is supplied to the adder 64. The adder 64 adds the multiplication results of the respective coefficient multipliers 63, 65, 66 to output the sum as a combined address read signal R_{K4}.

Each of the combined address read signals R_{K1}-RK₄ has a different combination ratio to the first address read signal R_{A1}-third address read signal R_{A3}, i.e.:

J1:K1:L1

J2:K2:L2

J3:K3:L3

J4:K4:L4

are different ratios from one another.

The combining circuit 50 supplies the combined address read signals R_{K1}-RK₄ to the first address generator circuit 51, second address generator circuit 52, third address generator circuit and fourth address generator circuit, respectively.

The first address generator circuit 51 performs a binary determination on the combined address read signal R_{K1} to generate a coded address data which is supplied to an error detection/correction circuit 55 as coded address data AD1. The error detection/correction circuit 55 performs error detection processing on the coded address data AD1, and supplies a detection result signal ER1 indicative of the error detection result to an error determination circuit 56. Further, the error detection/correction circuit 55 performs error correction processing on the coded address data AD1, and supplies a selector 57 with corrected address data A1 which has been corrected for errors.

The second address generator circuit 52 performs a binary determination on the combined address read signal R_{K2} to generate coded address data which is supplied to an error detection/correction circuit 58 as coded address data AD2. The error detection/correction circuit 58 performs error detection processing on the coded address data AD2, and supplies the error determination circuit 56 with a detection result signal ER2 indicative of the error detection result. Further, the error detection/correction circuit 58 performs error correction processing on the coded address data AD2, and supplies the selector 57 with corrected address data A2 which has been corrected for errors.

The third address generator circuit 53 performs a binary determination on the combined address read signal R_{K3} to generate coded address data which is supplied to an error detection/correction circuit 59 as coded address data AD3. The error detection/correction circuit 59 performs error detection processing on the coded address data AD3, and supplies the error determination circuit 56 with a detection result signal ER3 indicative of the error detection result. Further, the error detection/correction circuit 59 performs error correction processing on the coded address data AD3, and supplies the selector 57 with corrected address data A3 which has been corrected for errors.

The fourth address generator circuit 54 performs a binary determination on the combined address read signal R_{K4} to generate coded address data which is supplied to an error detection/correction circuit 60 as coded address data AD4. The error detection/correction circuit 60 performs error detection processing on the coded address data AD4, and supplies the error determination circuit 56 with a detection result signal ER4 indicative of the error detection result. Further, the error detection/correction circuit 60 performs error correction processing on the coded address data AD4, and supplies the selector 57 with corrected address data A4 which has been corrected for errors.

Each of the error detection result signals ER1-ER4 represents, for example, the following four error conditions C0-C3:

C0: no error

C1: error correctable, number of errors in one code block=1

C2: error correctable, number of errors in one code block=2

C3: error uncorrectable.

Specifically, in the error condition C0, no error exists in the coded address data AD, so that the corrected address data is most reliable. In the error condition C1, one error symbol exists in each of code blocks in the coded address data AD, so that even if the error is corrected by the error detection/correction circuit, the corrected address data A after the correction has a lower reliability than in the error condition C0. In the error condition C2, two errors exists in each of the code blocks in the coded address data AD, so that even if the errors are corrected by the error detection/correction circuit, the corrected address data after the correction has a lower reliability than in the error condition C1. Further, in the error condition C3, since errors cannot be corrected by the error detection/correction circuit, the corrected address data A has the lowest reliability.

The error determination circuit 56 determines the error detection result signal ER, among the error detection result signals ER1-ER3, which represents the error condition with the least number of correctable errors (the number of errors per code block), i.e., the error condition in which errors can be corrected and the error rate is lowest. Then, the error determination circuit 56 supplies the selector 57 with a selection signal for selecting the corrected address data A which corresponds to the determined error detection result signal ER.

The selector 57 selects one from the corrected address data A1-A4 supplied from the error detection/correction circuits 55, 58, 59, respectively, in accordance with the selection signal, and supplies the selected data to a recording/reproducing control circuit 48 as a reproduced disc address ADR. The recording/reproducing control circuit 48 controls a slider mechanism (not shown) for carrying the recording/reproducing head 32, spindle motor 33 and recording/reproducing head 32 in a radial direction of the disc in order for the information recording/reproducing apparatus to perform a variety of recording operations and reproducing operations in response to a variety of manipulations from the user. During a recording operation, the recording/reproducing control circuit 48 searches for a desired disc position on the recording disc 30 based on the reproduced disc address ADR in order to start recording from the desired position.

As described above, in the information recording/reproducing apparatus illustrated in FIG. 5, first, disc addresses modulated in three types of modulation schemes different from one another (first modulation-third modulation) are individually demodulated from a read signal read from the recording disc 30 to generate the first address read signal R_{A1}-third address read signal R_{A3}. Next, these first address read signal R_{A1} to third address read signal R_{A3} are combined in different combination ratios from one another to generate four combined address read signals R_{K1}-R_{K4}. Next, the binary determination is made individually on each of the combined address read signals R_{K1}-R_{K4} to generate coded address data AD1-AD4. Next, the error correction processing is performed on each of the coded address data AD1-AD4 to generate corrected address data A1-A4, and the error detection processing is performed on each of the coded address data AD1-AD4 to generate the detection result signal ER1-ER4, each indicative of an associated error condition. Then, the corrected address data A corresponding to the error detection result signal ER representative of the correctable and lowest error condition is selected from the error detection result signals ER1-ER4 as a final reproduced disc address.

Thus, according to the information recording/reproducing apparatus illustrated in FIG. 5, a relatively reliable disc address can be acquired from the recording disc, even if scratches, finger prints, dust and the like stick to the surface of the recording disc.

While the information recording/reproducing apparatuses illustrated in FIGS. 3 and 5 employ a number of the error detection/correction circuits (41, 43, 45, 55, 58-60) as much as the address generator circuits (40, 42, 44, 51-54), a single error detection/correction circuit may be provided instead irrespective of the number of address generator circuits.

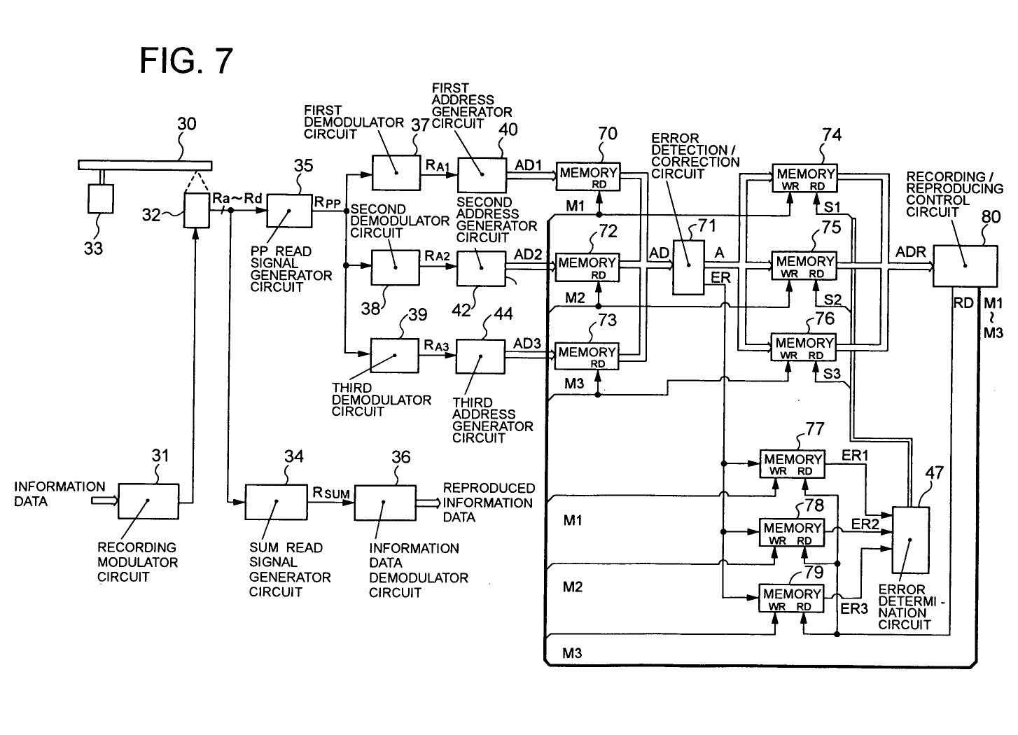

FIG. 7 is a diagram illustrating an exemplary variation of the information recording/reproducing apparatus illustrated in FIG. 3, which is made in view of the foregoing aspect.

In the information recording/reproducing apparatus illustrated in FIG. 7, a single error detection/correction circuit 71 is employed instead of the three error detection/correction circuits 41, 43, 45 shown in FIG. 3, and memories 70, 72-79 are added between the first to third address generators (40, 42, 44) and selector 46. Otherwise, each of the function modules designated the same reference numerals as those shown in FIG. 3 is identical in operation to its counterpart shown in FIG. 3, so that description thereon is omitted.

In FIG. 7, the memory 70 sequentially stores the coded address data AD1 generated by the first address generator circuit 40. While the memory 70 is being supplied with a memory access signal M1 from a recording/reproducing control circuit 80, the coded address data AD1 is read out in an order in which it has been stored, and supplied to the error detection/correction circuit 71 as coded address data AD.

The memory 72 sequentially stores the coded address data AD2 generated by the second address generator circuit 42. While the memory 72 is being supplied with a memory access signal M2 from the recording/reproducing control circuit 80, the coded address data AD2 is read out in an order in which it has been stored, and supplied to the error detection/correction circuit 71 as coded address data AD.

The memory 73 sequentially stores the coded address data AD3 generated by the third address generator circuit 44. While the memory 73 is being supplied with a memory access signal M3 from the recording/reproducing control circuit 80, the coded address data AD3 is read out in an order in which it has been stored, and supplied to the error detection/correction circuit 71 as coded address data AD.

The error detection/correction circuit 71 performs error detection processing on the coded address data AD supplied from the memory 70, 72 or 73, and supplies each of the memories 77-79 with an error detection result signal ER indicative of the error correction result. Further, the error detection/correction circuit 71 performs error correction processing on the coded address data AD, and supplies each of the memories 74-76 with corrected address data A which has been corrected for errors.

The error detection result signal ER represents, for example, the following four error conditions C0-C3:

C0: no error

C1: error correctable, number of errors in one code block=1

C2: error correctable, number of errors in one code block=2

C3: error uncorrectable.

The memory 74 sequentially stores the corrected address data A supplied from the error detection/correction circuit 71 as corrected address data A1 while it is being supplied with the memory access signal M1 from the recording/reproducing control circuit 80. Also, while the memory 74 is being supplied with a selection signal S1 from the error determination circuit 47, the corrected address data A1 is read in an order in which it has been stored, and supplied to the recording/reproducing control circuit 80 as a reproduced disc address ADR.

The memory 75 sequentially stores the corrected address data A supplied from the error detection/correction circuit 71 as corrected address data A2 while the memory access signal M2 is supplied to the memory 75 from the recording/reproducing control circuit 80. Also, while a selection signal S2 is supplied to the memory 75 from the error determination circuit 47, the memory 75 reads out the corrected address data A2 in an order in which it has been stored, and supplies the read out data to the recording/reproducing control circuit 80 as a reproduced disc address ADR.

The memory 76 sequentially stores the corrected address data A supplied from the error detection/correction circuit 71 as corrected address data A3 while it is being supplied with the memory access signal M3 from the recording/reproducing control circuit 80. Also, while the memory 76 is being supplied with a selection signal S3 from the error determination circuit 47, the corrected address data A3 is read in an order in which it has been stored, and supplied to the recording/reproducing control circuit 80 as a reproduced disc address ADR.

The memory 77 stores the error detection result signal ER supplied from the error detection/correction circuit 71 while it is being supplied with the memory access signal M1 from the recording/reproducing control circuit 80. Also, while the memory 77 is being supplied with a memory read signal RD from the recording/reproducing control circuit 80, the stored error detection result signal ER is read and supplied to the error determination circuit 47 as the error detection result signal ER1.

The memory 78 stores the error detection result signal ER supplied from the error detection/correction circuit 71 while it is being supplied with the memory access signal M2 from the recording/reproducing control circuit 80. Also, while the memory 78 is being supplied with the memory read signal RD from the recording/reproducing control circuit 80, the stored error detection result signal ER is read and supplied to the error determination circuit 47 as the error detection result signal ER2.

The memory 79 stores the error detection result signal ER supplied from the error detection/correction circuit 71 while it is being supplied with the memory access signal M3 from the recording/reproducing control circuit 80. Also, while the memory 79 is being supplied with the memory read signal RD from the recording/reproducing control circuit 80, the stored error detection result signal ER is read and supplied to the error determination circuit 47 as the error detection result signal ER3.

The recording/reproducing control circuit 80 first supplies only the memory access signal M1 among M1-M3 to the memories 70, 74, 77. In this way, the coded address data AD1 generated by the first address generator circuit 40 is supplied to the error detection/correction circuit 71 through the memory 70, and the error correction result is stored in the memory 74, while the error detection result in the memory 77, respectively. In other words, memory 74 stores the corrected address data A1 which is the error correction result for the coded address data AD1, while the memory 77 stores the error detection result signal ER1 which is the error detection result for the coded address data AD1.

Next, the recording/reproducing control circuit 80 supplies only the memory access signal M2 among M1-M3 to the memories 72, 75, 78. In this way, the coded address data AD2 generated by the second address generator circuit 42 is supplied to the error detection/correction circuit 71 through the memory 72, and the error correction result is stored in the memory 75, while the error detection result in the memory 78, respectively. In other words, the memory 75 stores the corrected address data A2 which is the error correction result for the coded address data AD2, while the memory 78 stores the error detection result signal ER2 which is the error detection result for the coded address data AD2.

Next, the recording/reproducing control circuit 80 supplies only the memory access signal M3 among M1-M3 to the memories 73, 76, 79. In this way, the coded address data AD3 generated by the third address generator circuit 44 is supplied to the error detection/correction circuit 71 through the memory 73, and the error correction result is stored in the memory 76, while the error detection result in the memory 79, respectively. In other words, the memory 76 stores the corrected address data A3 which is the error correction result for the coded address data AD3, while the memory 79 stores the error detection result signal ER3 which is the error detection result for the coded address data AD3.

Next, the recording/reproducing control circuit 80 supplies the memory read signal RD to the memories 74-79. In this way, each of the error detection result signals ER1-ER3 stored in the memories 77-79, respectively, is supplied to the error determination circuit 47.

The error determination circuit 47 first selects a detection result signal ER, among the error detection result signals ER1-ER3, which represents the error condition with the least number of correctable errors (the number of errors per code block), i.e., an error condition in which errors can be corrected and the error rate is lowest. Then, the error determination circuit 47 supplies a selection signal S only to one of the memories 74-76 which stores the corrected address data A corresponding to the error detection signal ER selected as described above. Specifically, when the selected error detection result signal ER corresponds to the corrected address data A1, the error determination circuit 47 supplies the selection signal S1 to the memory 74. When the selected error detection result signal ER corresponds to the corrected address data A2, the error determination circuit 47 supplies the selection signal S2 to the memory 75. When the selected error detection result signal ER corresponds to the corrected address data A3, the error determination circuit 47 supplies the selection signal S3 to the memory 76. In this event, the corrected address data A read from one of the memories 74-76 is supplied to the recording/reproducing control circuit 80 as a reproduced disc address ADR. The recording/reproducing control circuit 80 controls a slider mechanism (not shown) for carrying the recording/reproducing head 32, spindle motor 33 and recording/reproducing head 32 in a radial direction of the disc in order for the information recording/reproducing apparatus to perform a variety of recording operations and reproducing operations of the information recording/reproducing apparatus in response to a variety of manipulations from the user. During a recording operation, the recording/reproducing control circuit 80 searches for a desired disc position on the recording disc 30 based on the reproduced disc address ADR in order to start recording from the desired position.

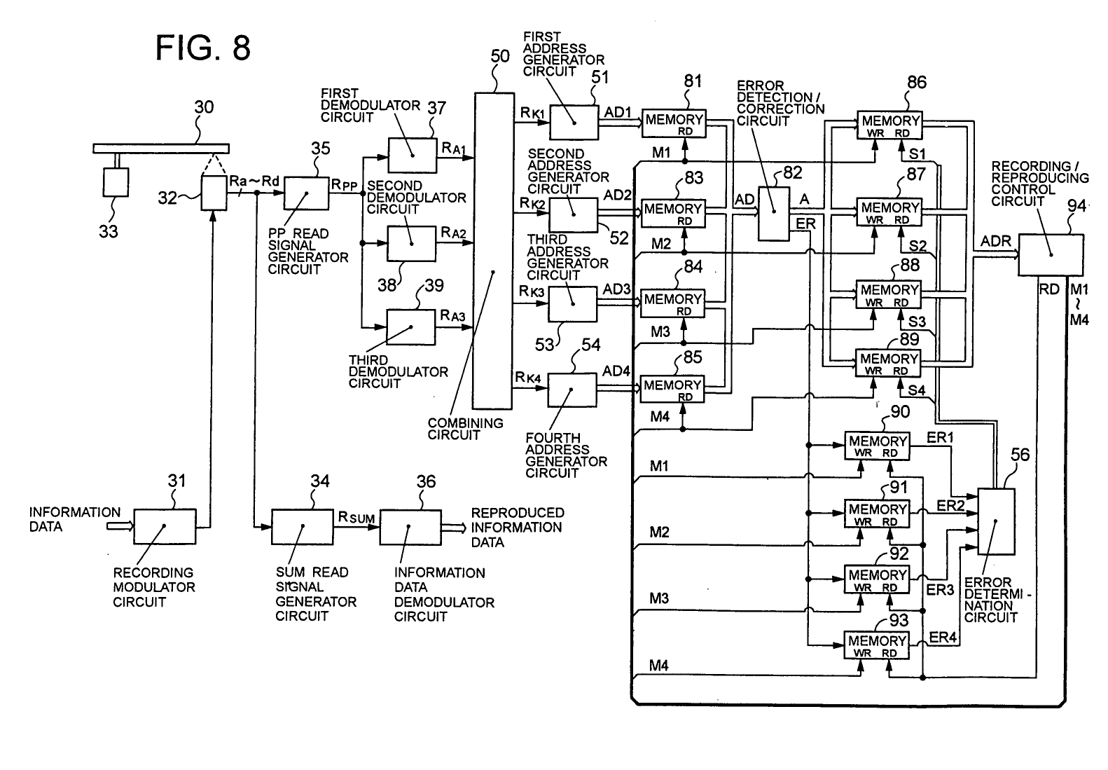

FIG. 8 is a diagram illustrating an exemplary variation of the information recording/reproducing apparatus illustrated in FIG. 5.

The information recording/reproducing apparatus illustrated in FIG. 8 employs a single error detection/correction circuit 82 instead of the four error detection/correction circuits 55, 58, 59, 60 shown in FIG. 5, and comprises memories 81 and 83-93 between the first to fourth address generator circuits 51-54 and selector 57. Otherwise, each of the function modules designated the same reference numerals as its counterpart shown in FIG. 3 is identical in operation to those shown in FIG. 5, so that description thereon will not repeated.

In FIG. 8, the memory 81 sequentially stores the coded address data AD1 generated by the first address generator circuit 51. While the memory 81 is being supplied with a memory access signal M1 from a recording/reproducing control circuit 94, the coded address data AD1 is read out in an order in which it has been stored, and supplied to the error detection/correction circuit 82 as coded address data AD.

The memory 83 sequentially stores the coded address data AD2 generated by the second address generator circuit 52. While the memory 83 is being supplied with a memory access signal M2 from the recording/reproducing control circuit 94, the coded address data AD2 is read out in an order in which it has been stored, and supplied to the error detection/correction circuit 82 as coded address data AD.

The memory 84 sequentially stores the coded address data AD3 generated by the third address generator circuit 53. While the memory 84 is being supplied with a memory access signal M3 from the recording/reproducing control circuit 94, the coded address data AD3 is read out in an order in which it has been stored, and supplied to the error detection/correction circuit 82 as coded address data AD.

The memory 85 sequentially stores the coded address data AD4 generated by the fourth address generator circuit 54. While a memory access signal M4 is supplied from the recording/reproducing control circuit 94, the memory 85 reads out the coded address data AD4 in an order in which it has been stored, and the read out data is supplied to the error detection/correction circuit 82 as coded address data AD.

The error detection/correction circuit 82 performs error detection processing on the coded address data AD supplied from the memory 81, 83, 84 or 85, and supplies an error detection result signal ER indicative of the error correction result to the memories 90-93. Further, the error detection/correction circuit 82 performs error correction processing on the coded address data AD, and supplies each of the memories 86-89 with corrected address data A which has been corrected for errors.

The error detection result signal ER represents, for example, the following four error conditions C0-C3:

C0: no error

C1: error correctable, number of errors in one code block=1

C2: error correctable, number of errors in one code block=2

C3: error uncorrectable.

The memory 86 sequentially stores the corrected address data A supplied from the error detection/correction circuit 82 as corrected address data A1 while it is being supplied with the memory access signal M1 from the recording/reproducing control circuit 94. Also, while the memory 86 is being supplied with a selection signal S1 from the error determination circuit 56, the corrected address data A1 is read in an order in which it has been stored, and supplied to the recording/reproducing control circuit 80 as a reproduced disc address ADR.

The memory 87 sequentially stores the corrected address data A supplied from the error detection/correction circuit 82 as corrected address data A2 while it is being supplied with the memory access signal M2 from the recording/reproducing control circuit 94. Also, while the memory 87 is being supplied with a selection signal S2 from the error determination circuit 56, the corrected address data A2 is read in an order in which it has been stored, and supplied to the recording/reproducing control circuit 80 as reproduced disc address ADR.

The memory 88 sequentially stores the corrected address data A supplied from the error detection/correction circuit 82 as corrected address data A3 while it is being supplied with the memory access signal M3 from the recording/reproducing control circuit 94. Also, while the memory 88 is being supplied with a selection signal S3 from the error determination circuit 56, the corrected address data A3 is read in an order in which it has been stored, and supplied to the recording/reproducing control circuit 80 as a reproduced disc address ADR.

The memory 89 sequentially stores the corrected address data A supplied from the error detection/correction circuit 82 as corrected address data A4 while it is being supplied with the memory access signal M4 from the recording/reproducing control circuit 94. Also, while the memory 89 is being supplied with a selection signal S4 from the error determination circuit 56, the corrected address data A4 is read in an order in which it has been stored, and supplied to the recording/reproducing control circuit 80 as a reproduced disc address ADR.

The memory 90 stores the error detection result signal ER supplied from the error detection/correction circuit 82 while it is being supplied with the memory access signal M1 from the recording/reproducing control circuit 94. Also, when the memory 90 is being supplied with a memory read signal RD from the recording/reproducing control circuit 94, the stored error detection result signal ER is read and supplied to the error determination circuit 56 as the error detection result signal ER1.

The memory 91 stores the error detection result signal ER supplied from the error detection/correction circuit 82 while it is being supplied with the memory access signal M2 from the recording/reproducing control circuit 94. Also, when the memory 91 is being supplied with the memory read signal RD from the recording/reproducing control circuit 94, the stored error detection result signal ER is read and supplied to the error determination circuit 56 as the error detection result signal ER2.

The memory 92 stores the error detection result signal ER supplied from the error detection/correction circuit 82 while it is being supplied with the memory access signal M3 from the recording/reproducing control circuit 94. Also, when the memory 92 is being supplied with the memory read signal RD from the recording/reproducing control circuit 94, the stored error detection result signal ER is read and supplied to the error determination circuit 56 as the error detection result signal ER3.

The memory 93 stores the error detection result signal ER supplied from the error detection/correction circuit 82 while it is being supplied with the memory access signal M4 from the recording/reproducing control circuit 94. Also, when the memory 93 is being supplied with the memory read signal RD from the recording/reproducing control circuit 94, the stored error detection result signal ER is read and supplied to the error determination circuit 56 as the error detection result signal ER4.

The recording/reproducing control circuit 94 first supplies only the memory access signal M1 among M1-M4 to the memories 81, 86, 90. In this way, the coded address data AD1 generated by the first address generator circuit 51 is supplied to the error detection/correction circuit 82 through the memory 81, and the error correction result is stored in the memory 86, while the error detection result in the memory 90, respectively. In other words, the memory 86 stores the corrected address data A1 which is the error correction result for the coded address data AD1, while the memory 90 stores the error detection result signal ER1 which is the error detection result for the coded address data AD1.

Next, the recording/reproducing control circuit 94 supplies only the memory access signal M2 among M1-M4 to the memories 83, 87, 91. In this way, the coded address data AD2 generated by the second address generator circuit 52 is supplied to the error detection/correction circuit 82 through the memory 83, and the error correction result is stored in the memory 87, while the error detection result in the memory 91, respectively. In other words, the memory 87 stores the corrected address data A2 which is the error correction result for the coded address data AD2, while the memory 91 stores the error detection result signal ER2 which is the error detection result for the coded address data AD2.

Next, the recording/reproducing control circuit 94 supplies only the memory access signal M3 among M1-M4 to the memories 84, 88, 92. In this way, the coded address data AD3 generated by the third address generator circuit 53 is supplied to the error detection/correction circuit 82 through the memory 84, and the error correction result is stored in the memory 88, while the error detection result in the memory 92, respectively. In other words, the memory 88 stores the corrected address data A3 which is the error correction result for the coded address data AD3, while the memory 91 stores the error detection result signal ER3 which is the error detection result for the coded address data AD3.

Next, the recording/reproducing control circuit 94 supplies only the memory access signal M4 among M1-M4 to the memories 85, 89, 93. In this way, the coded address data AD4 generated by the fourth address generator circuit 54 is supplied to the error detection/correction circuit 82 through the memory 85, and the error correction result is stored in the memory 89, while the error detection result in the memory 93, respectively. In other words, the memory 89 stores the corrected address data A4 which is the error correction result for the coded address data AD4, while the memory 93 stores the error detection result signal ER4 which is the error detection result for the coded address data AD4.

Next, the recording/reproducing control circuit 94 supplies the memory read signal RD to the memories 86-93. In this way, each of the error detection result signals stored in the memories 90-93, respectively, is supplied to the error determination circuit 56.

The error determination circuit 56 first selects a detection result signal ER, among the error detection result signals ER1-ER4, which represents the error condition with the least number of correctable errors (the number of errors per code block), i.e., an error condition in which errors can be corrected and the error rate is lowest. Then, the error determination circuit 56 supplies a selection signal S only to one of the memories 86-89 which stores the corrected address data A corresponding to the error detection signal ER selected as described above. Specifically, when the selected error detection result signal ER corresponds to the corrected address data A1, the error determination circuit 56 supplies the selection signal S1 to the memory 86. When the selected error detection result signal ER corresponds to the corrected address data A2, the error determination circuit 56 supplies the selection signal S2 to the memory 87. When the selected error detection result signal ER corresponds to the corrected address data A3, the error determination circuit 56 supplies the selection signal S3 to the memory 88. When the selected error detection result signal ER corresponds to the corrected address data A4, the error determination circuit 56 supplies the selection signal S4 to the memory 89. In this event, the corrected address data A read from one of the memories 86-89 is supplied to the recording/reproducing control circuit 94 as a reproduced disc address ADR.

The recording/reproducing control circuit 94 controls a slider mechanism (not shown) for carrying the recording/reproducing head 32, spindle motor 33 and recording/reproducing head 32 in a radial direction of the disc in order for the information recording/reproducing apparatus to perform a variety of recording operations and reproducing operations of the information recording/reproducing apparatus in response to a variety of manipulations from the user. During a recording operation, the recording/reproducing control circuit 80 searches for a desired disc position on the recording disc 30 based on the reproduced disc address ADR in order to start recording from the desired position.

As described above, by modifying the configuration illustrated in FIG. 3 (or FIG. 5) to that as illustrated in FIG. 7 (or FIG. 8), the error detection/correction processing can be performed on each of demodulated disc addresses in respective modulation schemes by a single error detection/correction circuit.

This application is based on Japanese Patent Application No. 2002-232880 which is herein incorporated by reference.

What is claimed is:

1. An information recording/reproducing apparatus for reproducing an address indicative of a recording position on a recording medium from the recording medium on which address data obtained by modulating the address in at least two modulation schemes different from each other are recorded, said apparatus comprising:
a demodulator for performing a demodulation processing on a read signal read from said recording medium corresponding to each of the modulation schemes to generate an address data signal for each demodulation processing;
an error corrector for performing error correction processing on each of the address data signals to generate a corrected address data signal corresponding to each of the address data signals; and
an address output part for selectively outputting the corrected address data signal corresponding to the address data signal having the lowest error ratio among the address data signals as a reproduced address.

2. An information recording/reproducing apparatus according to claim 1, further comprising:
an error detector for performing error detection processing on each of the address data signals to generate an error detection result signal including an error ratio of each of said address data signals, and information indicating whether or not each of the address data signals can be corrected by said error corrector,
wherein said an address output part includes:
a determining part for determining based on the error detection result signal an address data signal which is correctable and has the lowest error ratio from said address data signals; and
a selector for selecting a corrected address data signal corresponding to the address data signal determined by said determining part from said corrected address data signals to output the corrected address data signal selected thereby as the reproduced address.

3. An information recording/reproducing apparatus for reproducing an address indicative of a recording position on a recording medium from the recording medium on which the address data obtained by modulating the address in at least two modulation schemes different from each other are recorded, said apparatus comprising:
a demodulator for performing a demodulation processing on a read signal read from said recording medium corresponding to each of the modulation scheme to generate an address signal for each demodulation processing;
a combining part for combining the respective read signals generated for the respective demodulation schemes with one another at combination ratios different from one another to generate a plurality of combined read address signals;
an address generating part for performing a binary determination on each of the combined read address signals to generate an address data signal;
an error corrector for performing error correction processing on each of the address data signals to generate a corrected address data signal corresponding to each of the address data signals; and
an address output part for outputting the corrected address data corresponding to the address data signal having the lowest error ratio among said address data signals as a reproduced address.

4. An information recording/reproducing apparatus according to claim 3, further comprising:
an error detector for performing error detection processing on each of the address data signals to generate an error detection result signal including an error ratio of each of said address data signals, and information indicating whether or not each of the address data signals can be corrected by said error corrector,
wherein said address output part includes:
a determining part for determining based on the error detection result signal an address data signal which is correctable and has the lowest error ratio from said address data signals; and
a selector for selecting a corrected address data signal corresponding to the address data signal determined by said determining part from said corrected address data signals to output the corrected address data signal selected thereby as the reproduced address.

5. An information reproducing method for reproducing an address indicative of a recording position on a recording medium from the recording medium on which address data obtained by modulating the address in at least two modulation schemes different from each other are recorded, said method comprising:
a demodulating step for performing a demodulation processing on a read signal read from said recording medium corresponding to each of the modulation schemes to generate an address data signal for each demodulation processing;
an error correcting step for performing error correction processing on each of the address data signals to generate a corrected address data signal corresponding to each of the address data signals; and
an address outputting step for outputting the corrected address data signal corresponding to the address data signal having the lowest error ratio among the address data signals as a reproduced address.

6. An information reproducing method according to claim 5, further comprising:
an error detecting step for performing error detection processing on each of the address data signals to generate an error detection result signal including an error ratio of each of said address data signals, and information indicating whether or not each of the address data signals can be corrected,
wherein said address outputting step includes:
a determining step for determining based on the error detection result signal an address data signal which is correctable and has the lowest error ratio from said address data signals; and
a selecting step for selecting a corrected address data signal corresponding to the address data signal determined in said determining step from said corrected address data signals to output the corrected address data signal selected thereby as the reproduced address.

7. An information reproducing method for reproducing an address indicative of a recording position on a recording medium from the recording medium on which address data obtained by modulating the address in at least two modulation schemes different from each other are recorded, said method comprising:
a demodulating step for performing a demodulation processing on a read signal read from said recording medium corresponding to each of the modulation schemes to generate an address signal for each demodulation processing;
a combining step for combining the respective read signals generated for the respective demodulation schemes with one another at combination ratios different from one another to generate a plurality of combined read address signals;
an address generating step for performing a binary determination on each of the combined read address signals to generate an address data signal;
an error correcting step for performing error correction processing on each of the address data signals to generate a corrected address data signal corresponding to each of the address data signals; and
an address outputting step for outputting the corrected address data corresponding to the address data signal having the lowest error ratio among said address data signals as a reproduced address.

8. An information reproducing method according to claim 7, further comprising:
an error detecting step for performing error detection processing on each of the address data signals to generate an error detection result signal including an error ratio of each of said address data signals, and information indicating whether or not each of the address data signals can be corrected,
wherein said address outputting step includes:
a determining step for determining based on the error detection result signal an address data signal which is correctable and has the lowest error ratio from said address data signals; and
a selecting step for selecting a corrected address data signal corresponding to the address data signal determined in said determining step from said corrected address data signals to output the corrected address data signal selected thereby as the reproduced address.
